(19) United States
(12) Patent Application Publication
(10) Pub. No.: US 2007/0160906 A1
(43) Pub. Date: Jul. 12, 2007

(54) CATHODE MATERIALS FOR LITHIUM SECONDARY BATTERIES

(76) Inventors: Tatsuya TOOYAMA, Tokai (JP); Toyotaka Yuasa, Hitachi (JP); Sai Ogawa, Tokai (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/620,197

(22) Filed: Jan. 5, 2007

(30) Foreign Application Priority Data
Jan. 6, 2006 (JP) 2006-001012

(51) Int. Cl. H01M 4/50; H01M 4/52

(52) U.S. Cl. 429/223; 429/224; 429/231.3

(57) ABSTRACT

The present invention provides a lithium secondary battery small in the volume variation caused by charge-discharge and excellent in cycle performance. The lithium secondary battery includes a cathode capable of storing and releasing lithium and an anode capable of storing and releasing lithium, the cathode including a lithium-nickel-manganese-cobalt compound oxide having a layered crystal structure and a lithium-manganese compound oxide having a layered crystal structure distributed in the lithium-nickel-manganese-cobalt compound oxide.

### BACKGROUND OF THE INVENTION

1. Field of the Invention

The present invention relates to lithium secondary batteries.

2. Background Art

Recently, lithium secondary batteries each have a high energy density and a high voltage, and accordingly are widely used as power sources for personal computers, mobile devices and the like. Additionally, lithium secondary batteries are promising as power sources for environment-friendly electric vehicles and hybrid electric vehicles.

In Patent Document 1, an attempt has been made to improve the capacity retention rate by using a cathode material concomitantly including a LiMO₂-type compound oxide having the α-NaFeO₂ structure and Li₂MnO₃. This cathode material is less than 0.04 in the ratio (s/m) of the diffraction peak intensity (s) at a diffraction angle of 2θ=21±1.5° to the diffraction peak intensity (m) at a diffraction angle of 2θ=18.6±0.3° in a chart of the X-ray diffraction using the Cu Kα line, and Patent Document 1 discloses that this cathode material displays a high charge-discharge cycle performance.

[Patent Document 1] WO2003/044881

### SUMMARY OF THE INVENTION

Lithium secondary batteries are each required to have a further longer life, a further higher power density and a further lower cost, for the purpose of being used in vehicles.

The present invention has been achieved from the viewpoint that, in particular, lithium secondary batteries to be used in vehicles are each required to have a further longer life. Examples of the index of the long life may include a usable period of 10 years or longer, or a capacity retention rate after 1000 cycles of 85% or more.

The present invention is a lithium secondary battery including a cathode capable of storing and releasing lithium and an anode capable of storing and releasing lithium, the cathode including a lithium-nickel-manganese-cobalt compound oxide having a layered crystal structure and a lithium-manganese compound oxide having a layered crystal structure distributed in the lithium-nickel-manganese-cobalt compound oxide.

Additionally, the lithium-manganese compound oxide is preferably Li₂MnO₃.

The “distribution” as referred to in the present invention means the formation of the lithium-manganese compound oxide in the interface between the primary particles of the lithium-nickel-manganese-cobalt compound oxide wherein the primary particles of the lithium-nickel-manganese-cobalt compound oxide agglomerate into secondary particles, and further means the formation of the lithium-manganese compound oxide in the interior of the crystal of the lithium-nickel-manganese-cobalt compound oxide.

The lithium secondary battery of the present invention can be made to have a long life.

### BRIEF DESCRIPTION OF THE DRAWINGS

FIG. 1 is a schematic sectional view of a lithium secondary battery;

FIG. 2 is a chart of an X-ray diffraction measurement using the Cu Kα line;

FIG. 3 is a graph showing a relation between a diffraction intensity ratio and a volume variation rate; and

FIG. 4 is a schematic diagram showing a secondary battery system.

### DETAILED DESCRIPTION OF THE PREFERRED EMBODIMENTS

One embodiment to implement the present invention is described below.

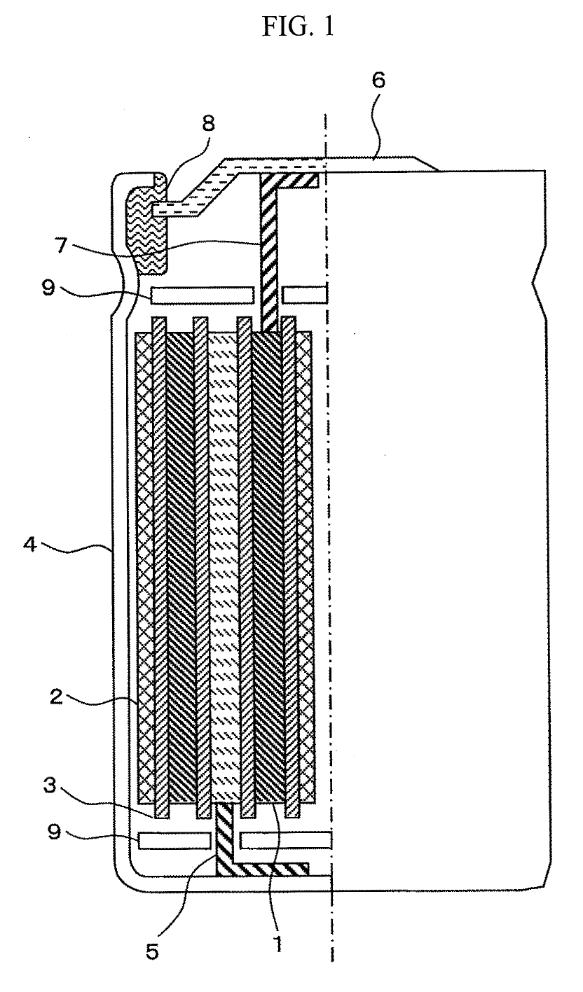

FIG. 1 is a view schematically showing the sectional shape of a lithium secondary battery.

In the lithium secondary battery, a cathode 1 and an anode 2 sandwich a separator 3 therebetween. The cathode 1, the anode 2 and the separator 3 are rolled and sealed in a stainless-steel or aluminum battery can 4 along with a nonaqueous electrolyte. A cathode lead 7 is formed for the cathode 1 and an anode lead 5 is formed for the anode 2 to take out the electric current. Insulating plates 9 are formed respectively between the cathode 1 and the anode lead 5 and between the anode 2 and the cathode lead 7. Between the battery can 4 in contact with the anode lead 5 and a cap 6 in contact with the cathode lead 7, there is formed a packing 8 to separate the plus electrode and the minus electrode from each other as well as to prevent the electrolyte leakage.

The cathode 1 is formed by coating a cathode material on a current collector made of aluminum or the like. The cathode material includes an active material contributing to the storage and release of lithium, a conducting agent, a binder and the like.

The anode 2 is formed by coating an anode material on a current collector made of copper or the like. The anode material includes an active material contributing to the storage and release of lithium, a conducting agent, a binder and the like. As the active materials of the anode 2, carbon materials such as amorphous carbon, graphite and a mixture of amorphous carbon and graphite are used.

As the active material of the cathode 1, a lithium-nickel-manganese-cobalt compound oxide (hereinafter referred to as “the compound oxide”) having a layered crystal structure is used. Additionally, the active material of the cathode 1 includes primary particles agglomerating to form secondary particles, and preferably has a hexagonal crystal unit lattice.

Specifically, as such a compound oxide, a compound oxide represented by a composition formula LiₐNiₓMn_{y}Co_{z}O₂ with the proviso that 0<a≦1.2, 0.10≦x≦0.45, 0.45≦y≦0.80, 0.1≦z≦0.3, and x+y+z=1 is used.

Here, the Li content a satisfies the relation 0<a≦1.2, the relation taking account of a state where the lithium secondary battery is charged (0<a) and a state where discharged (a≦1.2). It is to be noted that the Li content a preferably satisfies the relation 0.5≦a in the charged state.

Alternatively, when the relation 1.2<a holds, the contents of the transition metals Ni, Mn and Co in the compound oxide are decreased relative to the Li content to cause the capacity fading of the lithium secondary battery.

Accordingly, the Li content a in the compound oxide is set to satisfy the relation 0<a≦1.2, and additionally the compound oxide is made to include the lithium-manganese compound oxide distributed therein, and thus a high output power can also be attained.

In the present embodiment, as described above, the lithium-manganese compound oxide having a layered crystal structure is made to distribute in the compound oxide.

More specifically, the lithium-manganese compound oxide is formed in the interface between the primary particles of the compound oxide and/or in the interior of the crystal of the compound oxide.

It is to be noted that such a lithium-manganese compound oxide is required to be a so-called inactive material that does not store or release lithium, and is, in particular, preferably Li₂MnO₃.

It has been revealed that when the distribution ratio between the compound oxide and Li₂MnO₃ is represented in terms of the ratio of the peak intensities in the X-ray diffraction measurement using the Cu Kα line, the ratio (q/p) between the (003) diffraction peak intensity (p) of the compound oxide at a diffraction angle of 2θ=18.3±1° and the (020) diffraction peak intensity (q) of Li₂MnO₃ at a diffraction angle of 2θ=21.1±1° preferably falls in the range of 0.04≦q/p≦0.07.

Such a compound oxide including Li₂MnO₃ distributed therein is small in the volume variation rate of the crystal lattice caused by charge-discharge, and hence the lithium secondary battery can be expected to attain a long life, and displays a charge-discharge cycle performance high enough to be used as lithium secondary batteries for vehicles.

The fact that the expansion and shrinkage of the crystal structure of the compound oxide are small in case of charge-discharge can be specifically described such that the compound oxide has the lattice parameter a, the lattice parameter c and the crystal lattice volume V (=√3×a²c/2) of the hexagonal crystal thereof, in a state of 3.0 V to 4.2 V with reference to lithium metal, falling in the ranges of 2.80 Å≦a≦2.86 Å, 14.1 Å≦c≦14.5 Å and 98.9 Å³≦V≦101.0 Å³, respectively.

When the presence of Li₂MnO₃ adversely affects the crystal structure of the compound oxide, the crystal lattice of the compound oxide is distorted before and after charge-discharge. Accordingly, the lattice parameter a and the lattice parameter c are regulated to fall within the ranges of 2.80 Å≦a≦2.86 Å and 14.1 Å≦c≦14.5 Å, respectively, before and after charge-discharge.

When the crystal lattice parameter a is less than 2.80 Å, the crystal lattice in case of charge can hardly maintain the layered structure to degrade the cycle performance. On the other hand, when the crystal lattice parameter a exceeds 2.86 Å, the Li₂MnO₃ expands the crystal lattice of the compound oxide already in a state before charge-discharge, and the crystal structure of the compound oxide is destabilized to degrade the cycle performance.

When the crystal lattice parameter c falls outside the range of 14.1 Å≦c≦14.5 Å, it can be determined that the crystal structure is disturbed.

The lithium secondary battery using such a compound oxide as described above has an output power density of 2500 W/kg or more, preferably 3500 W/kg or more in a state of the depth of charge of 80%. Additionally, the lithium secondary battery has a capacity retention rate of 85% or more after 1000 cycles, and an upper limit of the output power density of approximately 4000 W/kg with some reservation.

In the present embodiment, various compound oxides and Li₂MnO₃ have been studied, and consequently it has been found that the control of the state of the presence and the control of the content of Li₂MnO₃ distributed in the compound oxide enable the control of the lattice volume variation of the compound oxide caused by charge-discharge.

Additionally, the presence of Li₂MnO₃ conceivably hinders the atomic exchange between the lithium layer and the transition metal layer in the compound oxide having a layered crystal structure. Thus, it is conceivable that the diffusion of the Li ions in the lithium layer in case of charge-discharge becomes hard to inhibit, and consequently the ion conductivity is improved to lead to an improvement of the output power.

Here, a particular attention is paid on Li₂MnO₃ for the purpose of suppressing the volume variation of the compound oxide, namely, the active material of the cathode caused by charge-discharge. This is because, although Li₂MnO₃ is electrochemically inactive, Li₂MnO₃ is an oxide of lithium and manganese that are also included in the compound oxide and Li₂MnO₃ is a material that has the same layered crystal structure as that of the compound oxide.

The compound oxide as the cathode active material undergoes the elongation of the axis c of the crystal lattice due to the enhanced repulsion between the adjacent oxygen atoms when the charge eliminates lithium from the crystal lattice. In this connection, the presence of Li₂MnO₃ distributed in the compound oxide alleviates the repulsion between the oxygen atoms to suppress the expansion of the axis c. Thus, the volume variation of the crystal lattice in case of charge conceivably becomes small. Consequently, in the lithium secondary battery undergoing repeated charge-discharge cycles, the expansion and shrinkage of the crystal structure becomes small, the deterioration of the compound oxide is suppressed and the long life thereof can be attained.

For the purpose of suppressing the volume variation of the compound oxide in case of charge-discharge, it has been found to be particularly effective that the Li₂MnO₃ distributed in the compound oxide as the cathode active material is such that the ratio (q/p) between the (003) diffraction peak intensity (p) of the compound oxide at a diffraction angle of 2θ=18.3±1° and the (020) diffraction peak intensity (q) of Li₂MnO₃ at a diffraction angle of 2θ=21.1±1° as a result of the X-ray diffraction measurement using the Cu Kα line is made to fall within a predetermined range.

In this connection, the condition that (q/p)<0.04 is insufficient to suppress the repulsion between the adjacent oxygen atoms at the time of elimination of lithium.

On the other hand, the condition that Li₂MnO₃ is present excessively in such a way that 0.07<(q/p) destabilizes the crystal structure of the compound oxide because Li₂MnO₃ is electrochemically inactive, increases the volume variation of the crystal lattice caused by charge-discharge, and causes adverse effects such as the capacity fading.

Only the condition satisfying the relation 0.04≦(q/p)≦0.07 can suppress the volume variation of the crystal lattice in case of charge-discharge. On the basis of such knowledge as described above, the content of Li₂MnO₃ distributed in the compound oxide has been found to be limited within a predetermined range.

It has also been found that under the condition that Li₂MnO₃ and the compound oxide are mixed together, the volume variation of the crystal lattice of the compound oxide caused by charge-discharge cannot be suppressed; it is required that Li₂MnO₃ be distributed in the compound oxide.

For the purpose of distributing Li₂MnO₃ in the compound oxide, the content of manganese in the compound oxide is crucial.

In other words, when the atomic ratio of manganese in the transition metals (nickel, cobalt and manganese) is less than 0.45, Li₂MnO₃ cannot be sufficiently generated to fail in suppressing the volume variation of the cathode active material caused by charge-discharge.

On the other hand, when the atomic ratio of manganese in the transition metals exceeds 0.80, Li₂MnO₃ is excessively generated and the adverse effects as the electrochemically inactive foreign substance outstrips the effect of suppressing the volume variation of the cathode active material caused by charge-discharge.

As described above, by setting the atomic ratio of manganese in the transition metals to be 0.45 or more and 0.80 or less, Li₂MnO₃ can be formed in an appropriate amount.

Additionally, when the atomic ratio of cobalt in the transition metals is less than 0.10, the crystal structure of the cathode active material is destabilized, and the volume variation of the cathode active material caused by charge-discharge is increased.

On the other hand, when the atomic ratio of cobalt in the transition metals exceeds 0.30, the cost becomes unfavorable and Li₂MnO₃ is hardly generated.

In consideration of the above-mentioned atomic ratios of manganese and cobalt in the transition metals, the atomic ratio of nickel in the transition metals is preferably 0.10 or more and 0.45 or less.

Further, the atomic ratio of lithium to the transition metals is associated with the capacity fading and the destabilization of the crystal structure, and is needed to be 1.2 or less.

Now, description is made below on the production method in the case where the compound oxide is adopted as the cathode active material.

As the raw materials for the cathode active material, the following can be used.

Examples of the lithium compounds may include lithium hydroxide and lithium carbonate; examples of the nickel compounds may include nickel hydroxide, nickel carbonate, nickel oxide, nickel sulfate and nickel nitrate; examples of the manganese compounds may include manganese carbonate, manganese oxide, manganese sulfate and manganese nitrate; and examples of the cobalt compounds may include cobalt hydroxide, cobalt carbonate, cobalt oxide, cobalt sulfate and cobalt nitrate.

The substances to be the raw materials are supplied as a powder including these substances in predetermined composition ratios, and the powder is milled and mixed by means of a mechanical method using a ball mill or the like. The milling and mixing may adopt either a dry method or a wet method. The maximum particle size of the milled raw material powder is preferably 1 μm or less and more preferably 0.3 μm or less.

Further, the thus milled raw material powder is needed to be granulated by spray drying. The granulation step is a step crucial for distributing Li₂MnO₃ in the compound oxide.

The powder thus obtained is fired at 850 to 1100° C., and preferably at 900 to 1050° C. The atmosphere for firing may be either an atmosphere of an oxidative gas such as air or an atmosphere of an inert gas such as nitrogen or argon, and an admixture of these atmospheres may also be used. Additionally, when the firing is carried out in two or more separate stages, each stage can be carried out in a different atmosphere.

As described above, the lithium secondary battery described in the present embodiment uses as the active material in the cathode thereof an oxide material in which the compound oxide having a layered crystal structure includes the lithium-manganese compound oxide, having a layered crystal structure, distributed therein.

Additionally, the lithium secondary battery described in the present embodiment uses in the cathode an oxide material, prepared by applying the granulation step, which includes the compound oxide having a layered crystal structure and the lithium-manganese compound oxide having a layered crystal structure.

Examples of a method for analyzing the presence/absence of the contained Li₂MnO₃ or the state of the contained Li₂MnO₃ in the cathode active material thus obtained may include the X-ray diffraction measurement and the particle analysis.

In the X-ray diffraction measurement, the peaks originating from the crystal planes of the cathode active material and Li₂MnO₃ can be identified. Additionally, from the results of the X-ray diffraction measurement, the lattice parameters of the unit lattice of the cathode active material can be obtained, and the lattice parameters and the lattice volume of the crystal lattice of the cathode active material before and after charge-discharge can be derived.

On the other hand, in the particle analysis measurement, the proportions of the elements which are contained in the cathode active material and do not form compounds with reference elements, namely, the proportions of the elements being in mixed states with the reference elements can be derived as the isolation rates.

The particle analysis measurement is carried out as follows.

First, the particles of the cathode active material are sucked up with an aspirator. The sucked particles are successively introduced into plasmas and are instantly evaporated therein to be atomized, ionized and further excited. By observing the emission spectrum due to this excitation, the elementary analysis of the particles is carried out.

When a compound including manganese and cobalt, for example, is measured, the emission spectra of manganese and cobalt can be observed simultaneously.

On the other hand, in a state where the particles of manganese and the particles of cobalt are mixed, the excitation times for the former and latter particles are different, and accordingly the emission spectra of manganese and cobalt are observed at different times.

For the respective particles, the third root of the obtained emission voltage ascribable to the cobalt atoms is represented as the X value, and the third root of the obtained emission voltage ascribable to the manganese atoms is represented as the Y value; thus, each of the particles is represented by the two-dimensional coordinates (X, Y). The use of the third root of the emission voltage is based on the fact that the third root of the number of the atoms is proportional to the particle size on the assumption that the particles are spherical in shape, and is a common method of representation. Here, the proportion of the number of the particles represented on the X axis or the Y axis in the total number of the particles is referred to as the isolation rate.

In the above-mentioned example, the proportion of the particles represented on the Y axis corresponds to the isolation rate of the particles composed of manganese without containing cobalt therein such as the isolation rate of Li₂MnO₃.

When the particle analysis is applied to the compound oxide in which Li₂MnO₃ is identified in the X-ray diffraction measurement, the isolation rate of manganese in relation to cobalt is as small as 0.1 to 1% as the case may be. In such a case, it can be said that Li₂MnO₃ is not mixed but distributed in the compound oxide.

Thus, when the isolation rate of manganese in relation to cobalt is 1% or less, Li₂MnO₃ can be regarded to be distributed in the compound oxide.

In the lithium secondary battery in the present embodiment, the cathode thereof includes the compound oxide and the lithium-manganese compound oxide having a layered crystal structure, the (020) diffraction peak of the lithium-manganese compound oxide such as Li₂MnO₃ at a diffraction angle of 2θ=21.1±1° in the X-ray diffraction measurement using the Cu Kα line is identified, and the isolation rate of Mn in relation to Co, in particular, the isolation rate of manganese of the lithium-manganese compound oxide in relation to cobalt of the compound oxide is 1% or less. It is to be noted that the isolation rate concerned is preferably 0.1% to 0.8%.

An example of the method for fabricating the lithium secondary battery is shown as follows.

The cathode active material is mixed with a conducting agent made of a carbon material powder and a binder such as poly vinylidene fluoride to prepare a slurry. The mixing ratio of the conducting agent to the cathode active material is preferably 5 to 20% by weight. Additionally, the mixing ratio of the binder to the cathode active material is preferably 1 to 10% by weight.

In this case, for the purpose of homogeneously dispersing the cathode active material in the slurry, it is preferable that a sufficient kneading be carried out by using a mixing machine.

The slurry thus obtained is coated as a current collector on both sides of a 15 to 25 μm thick aluminum foil by using a coating machine such as a transfer roll printing coating machine or the like. After coating both sides, the coated aluminum foil is press-dried to form an electrode plate of the cathode 1. The thickness of the composite portion composed of a mixture of the cathode active material, the conducting agent and the binder is preferably 20 to 100 μm.

For the anode active material, graphite, amorphous carbon or a mixture of these materials is used. In the same manner as in the case of the cathode 1, the anode active material is mixed with a binder, the mixture thus obtained is coated and press-dried to form an electrode plate of the anode 2.

The thickness of the composite portion of the anode 2 is preferably 20 to 70 μm. For the anode 2, a 7 to 20 μm thick copper foil is used as the current collector. The mixing ratio in the coating is preferably such that the weight ratio of the anode active material to the binder is approximately from 85:15 to 95:5.

The electrode plates thus obtained are each cut to a predetermined length to produce the electrode plates of the cathode 1 and the anode 2. Then, tabs for taking out the electric current are formed by spot welding or ultrasonic welding. The tabs are formed of metal foils which are the same in material as the rectangular current collectors, respectively, and are provided for the purpose of taking out the electric current from the electrodes, the tabs serving as a cathode lead 7 and an anode lead 5, respectively.

The cathode 1 and the anode 2, each having a tab fixed thereon, and a separator 3 formed of a porous resin such as polyethylene (PE) or polypropylene (PP) are laminated so as for the separator 3 to be interposed between the cathode 1 and the anode 2, the thus obtained laminate is rolled into a cylindrical shape to form a group of electrodes, and the group of electrodes is housed in a battery can 4 that is a cylindrical vessel.

Alternatively, bag-like separators may be used to house the electrodes therein, and such separators each including an electrode may be laminated to be housed in a rectangular vessel. The material for forming the vessel is preferably stainless steel or aluminum.

After the group of electrodes has been housed in the battery can 4, a nonaqueous electrolyte is poured into the can 4, and then a cap 6 and a packing 8 are used to seal the battery can 4.

It is preferable to use as the nonaqueous electrolyte an electrolyte which is prepared by dissolving, as a solute to be an electrolyte, a lithium salt such as LiPF₆, LiBF₄ or LiClO₄ in a solvent such as ethylene carbonate (EC), propylene carbonate (PC), dimethyl carbonate (DMC), methylethyl carbonate (MEC) or diethyl carbonate (DEC). The concentration of the electrolyte is preferably 0.7 M to 1.5 M.

The lithium secondary battery fabricated as described above has a configuration in which a pair of a cathode and an anode face each other through the intermediary of the separator and the nonaqueous electrolyte, has the cathode active material represented by the composition formula LiₐNiₓMn_{y}Co_{z}O₂ with the proviso that 0<a≦1.2, 0.10≦x≦0.45, 0.45 ≦y≦0.80, 0.1≦z≦0.3, and x+y+z=1, and has Li₂MnO₃ included in the cathode active material. The use of such a cathode enables the provision of a lithium secondary battery having a high output power performance and an excellent cycle performance.

Hereinafter, detailed description is made on Examples, but the present invention is not limited by these Examples.

### EXAMPLE 1

Description is made on the preparation of the cathode active material.

In Example 1, nickel oxide, manganese dioxide and tricobalt tetraoxide were used as the raw materials and were weighed out so as for the ratio Ni:Mn:Co to be 0.200:0.500:0.300 in terms of atomic ratio. The weighed raw materials were milled and mixed with a wet milling machine to prepare a milled powder mixture. The particles of the milled powder mixture thus obtained were subjected to a particle size distribution measurement to reveal that the mean particle size was 0.23 μm.

Then, polyvinyl alcohol (PVA) was added as a binder to the milled powder mixture in a content of 1% by weight in relation to the raw materials. The milled powder mixture thus obtained was granulated by using a spray dryer. The granulated powder thus obtained was placed in a high-purity alumina vessel, and subjected to a preliminary firing at 600° C. for 12 hours to evaporate PVA, thereafter cooled in air, and then disintegrated.

Further, lithium hydroxide monohydrate was added to and mixed with the disintegrated powder in such a way that the atomic ratio of Li:the transition metals (Ni, Mn and Co) is 1.2:1.0.

The mixed powder thus obtained was placed in a high-purity alumina vessel, and was subjected to a final firing at 1050° C. for 12 hours. The cathode active material thus obtained was disintegrated and classified.

Now, description is made on the evaluation of the properties of the cathode active material.

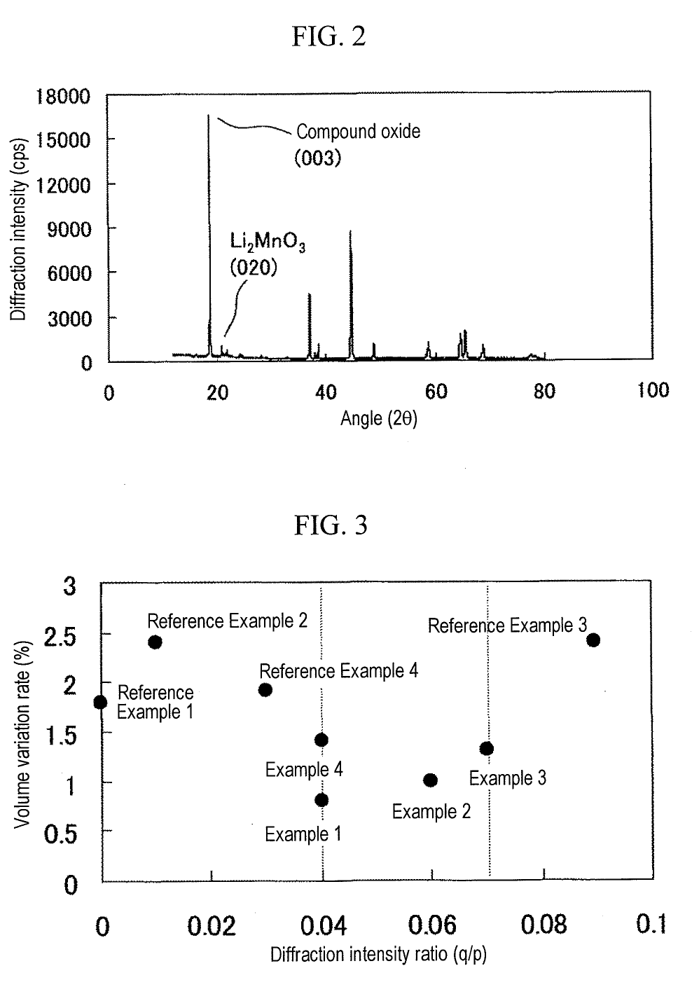

FIG. 2 shows an X-ray diffraction chart of the cathode active material measured by using the Cu Kα line. In FIG. 2, the diffraction intensity (cps:count/second) is shown as a function of the angle (2θ).

From FIG. 2, the diffraction peak conceivably ascribable to the layered structure belonging to R3-m, namely, the (003) diffraction peak of the compound oxide as the cathode active material was identified around 2θ=18.6°. Additionally, the (020) diffraction peak of Li₂MnO₃ was identified around 2θ=20.8°.

Here, with respect to the crystallographic representation, it is to be noted that the representation of “R3-m” is adopted as a convenient substitute for the formal symbol “R3m” assumed to have a minus sign “−” put over the digit “3.”

The intensity ratio of the diffraction peak around 2θ=20.8° to the diffraction peak around 2θ=18.6° was found to be 0.04.

Additionally, the crystal lattice belonging to R3-m was found to have the lattice parameter a of 2.85 Å, the lattice parameter c of 14.1 Å and the crystal lattice volume V of 99.5 Å³.

The results of the particle analysis measurement of the cathode active material obtained in Example 1 are shown in Table 1.

Table 1 shows the isolation rates of nickel and manganese in relation to cobalt as the reference. As can be seen from Table 1, the isolation rate of manganese in relation to cobalt is 0.19%, and the isolation rate of nickel in relation to cobalt is 0.20%.

In other words, although the cathode active material obtained in Example 1 was identified to include Li₂MnO₃ from the results of the X-ray diffraction measurement, the results of the analysis of the individual particles were little able to identify the Li₂MnO₃ particles.

Consequently, it has been verified that the cathode active material obtained in Example 1 is not in a mixed state in which Li₂MnO₃ is mixed with the compound oxide, but is in a state in which Li₂MnO₃ is distributed in the compound oxide.

TABLE 1

| | | | Isolation rate |
|---|---|---|---|
| | | | in base |
| Reference | Ch | Element | material (%) |
| ◯ | 1 | Co | |
| | 2 | Ni | 0.19 |
| | 3 | Mn | 0.20 |

Description is made on the fabrication of the cathode.

By using the cathode active material thus obtained, a cathode was fabricated. The cathode active material, a carbon conducting agent and a binder dissolved beforehand in a solvent, namely, N-methyl-2-pyrrolidone (NMP) were mixed together in a ratio of 85.0:10.7:4.3 in terms of percent by mass, to prepare a slurry. The slurry thus mixed was coated on a 20 μm thick aluminum current collector.

Then, the thus coated current collector was dried at 120° C., and compacted by using a press machine so as to have an electrode density of 2.7 g/cm³. After compacting, a disc of 15 mm in diameter was blanked with a blanking die to prepare a cathode.

Description is made on the fabrication of a test battery.

The test battery was fabricated by using the cathode thus prepared, lithium metal as the anode, and an electrolyte containing 1.0 M LiPF₆ as an electrolyte dissolved in a mixed solvent of EC and DMC.

Description is made on the evaluation of the properties of the cathode.

The lattice parameters, the lattice volume and the lattice volume variation rate of the cathode after charge-discharge were evaluated on the basis of the following procedures. The test battery was used. The test battery was charged up to 4.2 V at a charge rate of 0.4 C with a constant current and a constant voltage, and thereafter discharged at a discharge rate of 0.4 C with a constant current down to a desired voltage. Subsequently, the test battery was disassembled to take out the cathode, and the cathode was subjected to an X-ray diffraction measurement. The results thus obtained are shown in Table 2.

TABLE 2
Table 2

| | | | | | | | | | | Lattice |
|---|---|---|---|---|---|---|---|---|---|---|
| | | | | | | | | | | volume |
| Cathode | Composition in | | | | Diffraction | | Lattice | Lattice | Lattice | variation |
| active | LiₐNiₓMn_{y}Co_{z}O₂ | | | | intensity | Charge-discharge | parameter a | parameter c | volume V | rate |
| material | a | x | y | z | ratio (q/p) | states | (Å) | (Å) | (Å³) | (%) |
| Example 1 | 1.2 | 0.200 | 0.500 | 0.300 | 0.04 | Before | 2.852 | 14.13 | 99.53 | 0 |
| | | | | | | charge-discharge | | | | |
| | | | | | | 4.0 V | 2.824 | 14.30 | 98.76 | 0.8 |

Table 2 shows, for the cathode of the test battery, the diffraction intensity ratio, and the values of the lattice parameter a, the lattice parameter c, the lattice volume V and the lattice volume variation rate before charge-discharge and in the charge-discharge state at 4.0 V.

The lattice volume variation rate means a value obtained from the difference between the lattice volume of the cathode charged up to 4.0 V and the lattice volume before the charge-discharge divided by the lattice volume before the charge-discharge.

As shown in Table 2, the lattice volume variation rate of Example 1 was as low as 0.8%.

Description is made on the fabrication of a 18650(18 mm in diameter and 650 mm in height)-type battery.

By using the obtained cathode active material, the 18650-type battery was fabricated. First, a slurry was prepared by mixing the cathode active material, a conducting agent made of graphite, a conducting agent made of carbon black and a binder made of PVDF in a weight ratio of 80:12:3:5, and the mixture thus obtained was added with an appropriate amount of NMP to prepare a slurry.

The prepared slurry was agitated with a planetary mixer for 3 hours so as to be kneaded.

Then, the kneaded slurry was coated on both sides of a 20 μm thick aluminum foil by using a transfer roll printing coating machine. The coated aluminum foil was pressed with a roll press so as for the composite density to be 2.7 g/cm³ to yield a cathode.

Amorphous carbon was used as the anode active material, a conducting agent made of carbon black was added to the amorphous carbon in an amount of 6.5% by weight, and the mixture thus obtained was agitated for 30 minutes with a slurry mixer to be kneaded.

The kneaded slurry was coated on both sides of a 10 μm thick copper foil by using a coating machine, the coated copper foil was dried and thereafter pressed with a roll press to yield an anode.

The electrodes, namely, the cathode and the anode were each cut to a predetermined size, and current collecting tabs were fixed to the electrode portions uncoated with the slurry by means of ultrasonic welding.

A porous polyethylene film was sandwiched between the electrodes, namely, the cathode and the anode, and the thus obtained laminate is rolled into a cylindrical shape and inserted into a can for the 18650-type battery.

A current collecting tab and the cap of the battery can were connected to each other, and then the battery was sealed by welding the cap of the battery can and the battery can to each other by means of laser welding.

Finally, a nonaqueous electrolyte was injected into the battery can from an injection opening formed on the battery can to fabricate a 18650-type battery. It is to be noted that the battery weight was 37 g.

Description is made on the evaluation of the output power performance.

The output power performance of the fabricated 18650-type battery was evaluated on the basis of the following procedures. First, the battery was constant current charged up to a charge cut voltage of 4.2 V by flowing a current of 1 mA/cm². After a rest of one hour, the battery was constant current discharged down to 2.7 V with a current set at the same value.

The output power density was evaluated in a state in which the battery was discharged to the depth of discharge of 20%. The voltage values at an elapsed time of 10 seconds after the discharge with the current values set at 10 A, 30 A and 90 A were determined, and these current values were used for an extrapolation to 2.5 V, and the output power was derived from the limiting current value corresponding to 2.5 V.

The output power density of the cathode of this battery was as high as 3580 W/kg.

Description is made on the evaluation of the cycle performance.

The cycle performance of the fabricated 18650-type battery was evaluated on the basis of the following procedures. First, the battery was constant current charged up to a charge cut voltage of 4.2 V by flowing a current of 1 mA/cm². After an intermission of one hour, the battery was constant current discharged down to 2.7 V with a current set at the same value.

This charge-discharge cycle was repeated 1000 times. The temperature of the test environment was set at 50° C.

The capacity retention rate of this battery was as high as 88.4%.

These output power performance and the cycle performance are collected in Table 3.

TABLE 3

| | Output power density (W/kg) | Capacity retention rate (%) |
|---|---|---|
| Example 1 | 3350 | 88.4 |

### EXAMPLE 2

In Example 2, a cathode active material was prepared in the same manner as in Example 1 except that the ratio Ni:Mn:Co was set to be 0.267:0.533:0.200 in terms of atomic ratio. By using a test battery incorporating this cathode active material, the properties of the cathode electrode were evaluated in the same manner as in Example 1.

In addition to the diffraction peak conceivably ascribable to the layered structure belonging to R3-m, a peak ascribable to the Li₂MnO₃ phase was able to be identified around 2θ=20.80.

The intensity ratio of the diffraction peak at 2θ=20.80 to the diffraction peak at 2θ=18.70 was found to be 0.06. It is to be noted that Li₂MnO₃ was distributed in the cathode active material.

The values of the lattice parameters, the lattice volume and the lattice volume variation rate before and after charge-discharge were as shown in Table 4 under the same indexes as in Table 2.

A 18650-type battery was fabricated in the same manner as in Example 1, and the output power performance and the cycle performance thereof were evaluated.

The output power density as the evaluation index of the output power performance and the capacity retention rate as the evaluation index of the cycle performance are shown in Table 5 under the same indexes as in Table 3.

It can be seen that the cathode electrode fabricated in Example 2 also exhibited high performances.

### EXAMPLE 3

In Example 3, a cathode active material was prepared in the same manner as in Example 1 except that the ratio Ni:Mn:Co was set to be 0.200:0.600:0.200 in terms of atomic ratio. By using a test battery incorporating this cathode active material, the properties of the cathode electrode were evaluated in the same manner as in Example 1.

In addition to the diffraction peak conceivably ascribable to the layered structure belonging to R3-m, a peak ascribable to the Li₂MnO₃ phase was able to be identified around 2θ=20.70.

The intensity ratio of the diffraction peak at 2θ=20.70 to the diffraction peak at 2θ=18.60 was found to be 0.07. It is to be noted that Li₂MnO₃ was distributed in the cathode active material.

Additionally, the values of the lattice parameters, the lattice volume and the lattice volume variation rate before and after charge-discharge were as shown in Table 4.

A 18650-type battery was fabricated in the same manner as in Example 1, and the output power performance and the cycle performance thereof were evaluated.

The output power density and the capacity retention rate are shown in Table 5.

It can be seen that the cathode electrode fabricated in Example 3 also exhibited high performances.

### EXAMPLE 4

In Example 4, a cathode active material was prepared in the same manner as in Example 1 except that the ratio Ni:Mn:Co was set to be 0.400:0.450:0.150 in terms of atomic ratio. By using a test battery incorporating this cathode active material, the properties of the cathode electrode were evaluated in the same manner as in Example 1.

In addition to the diffraction peak conceivably ascribable to the layered structure belonging to R3-m, a peak ascribable to the Li₂MnO₃ phase was able to be identified around 2θ=20.80.

The intensity ratio of the diffraction peak at 2θ=20.70 to the diffraction peak at 2θ=18.60 was found to be 0.04. It is to be noted that Li₂MnO₃ was distributed in the cathode active material.

Additionally, the values of the lattice parameters, the lattice volume and the lattice volume variation rate before and after charge-discharge were as shown in Table 4.

A 18650-type battery was fabricated in the same manner as in Example 1, and the output power performance and the cycle performance thereof were evaluated.

The output power density and the capacity retention rate are shown in Table 5.

It can be seen that the cathode electrode fabricated in Example 4 also exhibited high performances.

TABLE 4
Table 4

| | | | | | | | | | | Lattice |
|---|---|---|---|---|---|---|---|---|---|---|
| | | | | | | | | | | volume |
| Cathode | Composition in | | | | Diffraction | | Lattice | Lattice | Lattice | variation |
| active | LiₐNiₓMn_{y}Co_{z}O₂ | | | | intensity | Charge-discharge | parameter a | parameter c | volume V | rate |
| material | a | x | y | z | ratio (q/p) | states | (Å) | (Å) | (Å³) | (%) |
| Example 2 | 1.2 | 0.267 | 0.533 | 0.200 | 0.06 | Before | 2.856 | 14.16 | 99.97 | 0 |
| | | | | | | charge-discharge | | | | |
| | | | | | | 4.0 V | 2.825 | 14.32 | 98.97 | 1.0 |
| Example 3 | 1.2 | 0.200 | 0.600 | 0.200 | 0.07 | Before | 2.859 | 14.23 | 100.8 | 0 |
| | | | | | | charge-discharge | | | | |
| | | | | | | 4.0 V | 2.830 | 14.34 | 99.46 | 1.3 |
| Example 4 | 1.2 | 0.400 | 0.450 | 0.150 | 0.04 | Before | 2.860 | 14.22 | 100.7 | 0 |
| | | | | | | charge-discharge | | | | |
| | | | | | | 4.0 V | 2.831 | 14.30 | 99.25 | 1.4 |

TABLE 5

| | Output power density (W/kg) | Capacity retention rate (%) |
|---|---|---|
| Example 2 | 3220 | 86.9 |
| Example 3 | 3000 | 85.1 |
| Example 4 | 3090 | 86.0 |

### REFERENCE EXAMPLE 1

In Reference Example 1, the ratio Ni:Mn:Co was set to be 0.400:0.400:0.200 in terms of atomic ratio. Additionally, in Reference Example 1, a cathode active material was prepared fundamentally in the same manner as in Example 1 except that no granulation step was applied. By using a test battery incorporating this cathode active material, the properties of the cathode electrode were evaluated in the same manner as in Example 1.

In the case of Reference Example 1, the diffraction peak conceivably ascribable to the layered structure belonging to R3-m was able to be identified, but the peak ascribable to the Li₂MnO₃ phase was not able to be identified. Additionally, the values of the lattice parameters, the lattice volume and the lattice volume variation rate before and after charge-discharge were as shown in Table 7.

A 18650-type battery was fabricated in the same manner as in Example 1, and the output power performance and the cycle performance thereof were evaluated. The output power density and the capacity retention rate are shown in Table 8. As can be seen from Tables 7 and 8, the cathode electrode fabricated in Reference Example 1 is comparable in capacity retention rate with that fabricated in Example 1, but inferior in output power density to that fabricated in Example 1.

### REFERENCE EXAMPLE 2

In Reference Example 2, the ratio Ni:Mn:Co was set to be 0.450:0.450:0.100 in terms of atomic ratio. Additionally, in Reference Example 2, a cathode active material was prepared fundamentally in the same manner as in Example 1 except that the cathode active material was subjected to a preliminary firing at 800° C. for 12 hours and a final firing at 1050° C. for 12 hours.

By using a test battery incorporating this cathode active material, the properties of the cathode electrode were evaluated in the same manner as in Reference Example 1.

The results of the particle analysis measurement of the cathode active material obtained in Reference Example 1 are shown in Table 6.

TABLE 6

| | | | Isolation rate |
|---|---|---|---|
| | | | in base |
| Reference | Ch | Element | material (%) |
| ◯ | 1 | Co | |
| | 2 | Ni | 0.21 |
| | 3 | Mn | 6.80 |

As can be seen from FIG. 6, the isolation rate of nickel in relation to cobalt was 0.21% and the isolation rate of manganese in relation to cobalt was 6.80%, revealing that the isolation rate of manganese is larger than that of nickel.

In other words, it was revealed that the manganese contained in Li₂MnO₃ and the cobalt contained in the compound oxide, both identified by means of the X-ray diffraction measurement, each were in an isolated state. Consequently, the state of the cathode active material obtained in Reference Example 1 can be regarded as a mixed state involving Li₂MnO₃ and the compound oxide.

In the case of Reference Example 2, in addition to the diffraction peak conceivably ascribable to the layered structure belonging to R3-m, many peaks were able to be identified. The intensity ratio of the diffraction peak at 2θ=20.7° to the diffraction peak at 2θ=18.7° was found to be 0.01. Additionally, the values of the lattice parameters, the lattice volume and the lattice volume variation rate before and after charge-discharge were as shown in Table 7.

A 18650-type battery was fabricated in the same manner as in Reference Example 1, and the output power performance and the cycle performance thereof were evaluated. The output power density and the capacity retention rate are shown in Table 8. As can be seen from Tables 7 and 8, the cathode electrode fabricated in Reference Example 2 is inferior, both in output power density and in capacity retention rate, to that fabricated in Example 1.

### REFERENCE EXAMPLE 3

In Reference Example 3, the ratio Ni:Mn:Co was set to be 0.100:0.800:0.100 in terms of atomic ratio. Additionally, in Reference Example 3, a cathode active material was prepared fundamentally in the same manner as in Reference Example 2 except that the cathode material was subjected to a preliminary firing at 600° C. for 12 hours and a final firing at 900° C. for 12 hours. By using a test battery incorporating this cathode active material, the properties of the cathode electrode were evaluated in the same manner as in Reference Example 2.

In the case of Reference Example 3, in addition to the diffraction peak conceivably ascribable to the layered structure belonging to R3-m, many peaks were able to be identified. The intensity ratio of the diffraction peak at 2θ=20.8° to the diffraction peak at 2θ=18.7° was found to be 0.09. Additionally, the values of the lattice parameters, the lattice volume and the lattice volume variation rate before and after charge-discharge were as shown in Table 7.

A 18650-type battery was fabricated in the same manner as in Reference Example 2, and the output power performance and the cycle performance thereof were evaluated. The output power density and the capacity retention rate are shown in Table 8. As can be seen from Tables 7 and 8, the cathode electrode fabricated in Reference Example 3 is inferior, both in output power density and in capacity retention rate, to that fabricated in Example 1.

### REFERENCE EXAMPLE 4

In Reference Example 4, the ratio Ni:Mn:Co was set to be 0.250:0.500:0.250 in terms of atomic ratio. Additionally, in Reference Example 4, a cathode active material was prepared fundamentally in the same manner as in Reference Example 2 except that the cathode material was subjected to a preliminary firing at 700° C for 12 hours and a final firing at 1050° C. for 12 hours. By using a test battery incorporating this cathode active material, the properties of the cathode electrode were evaluated in the same manner as in Reference Example 2.

In the case of Reference Example 4, in addition to the diffraction peak conceivably ascribable to the layered structure belonging to R3-m, many peaks were able to be identified. The intensity ratio of the diffraction peak at 2θ=20.8° to the diffraction peak at 2θ=18.7° was found to be 0.03. Additionally, the values of the lattice parameters, the lattice volume and the lattice volume variation rate before and after charge-discharge were as shown in Table 7.

A 18650-type battery was fabricated in the same manner as in Reference Example 2, and the output power performance and the cycle performance thereof were evaluated. The output power density and the capacity retention rate are shown in Table 8. As can be seen from Tables 7 and 8, the cathode electrode fabricated in Reference Example 4 is inferior, both in output power density and in capacity retention rate, to that fabricated in Example 1.

TABLE 7
Table 7

| | | | | | | | | | | Lattice |
|---|---|---|---|---|---|---|---|---|---|---|
| | | | | | | | | | | volume |
| Cathode | Composition in | | | | Diffraction | | Lattice | Lattice | Lattice | variation |
| active | LiₐNiₓMn_{y}Co_{z}O₂ | | | | intensity | Charge-discharge | parameter a | parameter c | volume V | rate |
| material | a | x | y | z | ratio (q/p) | states | (Å) | (Å) | (Å³) | (%) |
| Reference | 1.2 | 0.400 | 0.400 | 0.200 | 0 | Before | 2.856 | 14.28 | 101.5 | 0 |
| Example 1 | | | | | | charge-discharge | | | | |
| | | | | | | 4.0 V | 2.818 | 14.49 | 99.65 | 1.8 |
| Reference | 1.2 | 0.450 | 0.450 | 0.100 | 0.01 | Before | 2.864 | 14.26 | 101.3 | 0 |
| Example 2 | | | | | | charge-discharge | | | | |
| | | | | | | 4.0 V | 2.814 | 14.56 | 98.82 | 2.4 |
| Reference | 1.2 | 0.100 | 0.800 | 0.100 | 0.09 | Before | 2.871 | 14.27 | 101.9 | 0 |
| Example 3 | | | | | | charge-discharge | | | | |
| | | | | | | 4.0 V | 2.819 | 14.45 | 99.44 | 2.4 |
| Reference | 1.2 | 0.250 | 0.500 | 0.250 | 0.03 | Before | 2.862 | 14.18 | 100.6 | 0 |
| Example 4 | | | | | | charge-discharge | | | | |
| | | | | | | 4.0 V | 2.804 | 14.49 | 98.66 | 1.9 |

TABLE 8

| | Output power density (W/kg) | Capacity retention rate (%) |
|---|---|---|
| Ref. Ex. 1 | 2520 | 86.5 |
| Ref. Ex. 2 | 2410 | 77.3 |
| Ref. Ex. 3 | 2180 | 71.5 |
| Ref. Ex. 4 | 2340 | 82.9 |

The above described evaluation results of Example 1 to Reference Example 4 are shown in FIG. 3. FIG. 3 shows the relation between the diffraction intensity ratio (q/p) and the volume variation rate (%). As can be seen from FIG. 3, those cases where the diffraction intensity ratio (q/p) is 0.04 or more and 0.07 or less exhibit excellent performance such that the volume variation rate is 1.5% or less.

According to the present embodiment, the distribution of Li₂MnO₃ in the compound oxide enables the formation of a cathode active material that is small in the lattice volume variation caused by charge-discharge, and also enables the provision of a high-output-power-performance and high-cycle-performance lithium secondary battery using such a cathode active material.

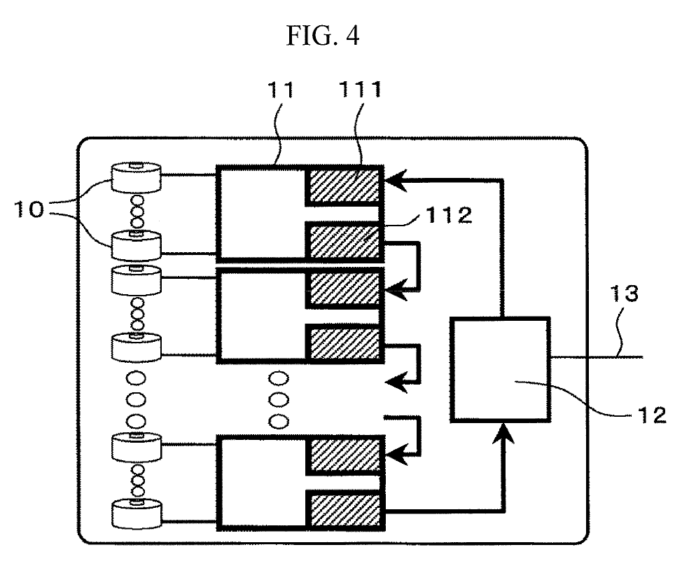

FIG. 4 schematically shows a secondary battery system incorporating the lithium secondary batteries fabricated in the present embodiment.

Two or more, for example 4 to 8, of the lithium secondary batteries 10 are connected in series to form a group of the lithium secondary batteries. Further, the secondary battery system has two or more of such groups of the lithium secondary batteries.

A cell controller 11 is formed so as to correspond to such a group of the lithium secondary batteries and controls the lithium secondary batteries 10. The cell controller 11 monitors the overcharge and the over discharge of the lithium secondary batteries 10 and the remaining capacity of the lithium secondary batteries 10.

A battery controller 12 provides signals to the cell controller 11 by using, for example, communication means, and receives signals from the cell controller 11 by using, for example, communication means.

The battery controller 12 controls the power input into and the power output from the cell controller 11.

The battery controller 12 provides signals to, for example, the input portion 111 of the first cell controller 11. Such signals are transmitted in series from the output portion 112 of the cell controller 11 to the input portion 111 of another cell controller 11. These signals are provided from the output portion 112 of the last cell controller 11 to the battery controller 12.

In this way, the battery controller 12 can monitor the cell controllers 11.

It is to be noted that the battery controller 12 is connected with a signal wire 13 to a control system of a vehicle, and outputs control signals on request issued from the vehicle.

The lithium secondary battery of the present invention is promising particularly as power sources for environment-friendly electric vehicles and hybrid electric vehicles.

What is claimed is:

1. A lithium secondary battery comprising a cathode capable of storing and releasing lithium and an anode capable of storing and releasing lithium, the cathode comprising:
a lithium-nickel-manganese-cobalt compound oxide having a layered crystal structure and a lithium-manganese compound oxide having a layered crystal structure distributed in the lithium-nickel-manganese-cobalt compound oxide.

2. The lithium secondary battery according to claim 1, wherein the lithium-manganese compound oxide is Li₂MnO₃.

3. The lithium secondary battery according to claim 1, wherein the lithium-nickel-manganese-cobalt compound oxide comprises primary particles agglomerating to form secondary particles and the lithium-manganese compound oxide is formed in the interface between the primary particles of the lithium-nickel-manganese-cobalt compound oxide.

4. The lithium secondary battery according to claim 1, wherein the lithium-manganese compound oxide is formed in the interior of the crystal of the lithium-nickel-manganese-cobalt compound oxide.

5. The lithium secondary battery according to claim 1, wherein the lithium-manganese compound oxide is an inactive material.

6. A lithium secondary battery comprising a cathode capable of storing and releasing lithium and an anode capable of storing and releasing lithium, the cathode comprising:
a lithium-nickel-manganese-cobalt compound oxide having a layered crystal structure and Li₂MnO₃, wherein the ratio (q/p) between the (003) diffraction peak intensity (p) of the lithium-nickel-manganese-cobalt compound oxide at a diffraction angle of 2θ=18.3±1° in an X-ray diffraction measurement using the Cu Kα line and the (020) diffraction peak intensity (q) of Li₂MnO₃ at a diffraction angle of 2θ=21.1±1° in the X-ray diffraction measurement using the Cu Kα line falls in the range of 0.04≦q/p≦0.07.

7. The lithium secondary battery according to claim 6, wherein the lithium-nickel-manganese-cobalt compound oxide has a hexagonal crystal unit lattice, and the lattice parameter a, the lattice parameter c and the crystal lattice volume V of the hexagonal crystal, in a state of 3.0 V to 4.2 V with reference to lithium metal, fall in the ranges of 2.80 Å≦a≦2.86 Å, 14.1 Å≦c≦14.5 Å and 98.9 Å³≦V≦101.0 Å³, respectively.

8. The lithium secondary battery according to claim 1, wherein the lithium-nickel-manganese-cobalt compound oxide is represented by a composition formula LiₐNiₓMn_{y}Co_{z}O₂ with the proviso that 0≦a≦1.2, 0.10≦x≦0.45, 0.45≦y≦0.80, 0.1≦z≦0.3, and x+y+z=1.

9. A lithium secondary battery comprising a pair of a cathode and an anode facing each other through the intermediary of a separator and a nonaqueous electrolyte, wherein the active material of the cathode is represented by the composition formula LiₐNiₓMn_{y}Co_{z}O₂ with the proviso that 0<a≦1.2, 0.10≦x≦0.45, 0.45≦y≦0.80, 0.1≦z≦0.3, and x+y+z=1, and the active material comprises Li₂MnO₃.

10. The lithium secondary battery according to claim 9, wherein the output power density thereof is 2500 W/kg or more under the condition that the depth of charge thereof is 80%.

11. The lithium secondary battery according to claim 9, wherein the capacity retention rate thereof after 1000 cycles is 85% or more.

12. A lithium secondary battery comprising a cathode capable of storing and releasing lithium and an anode capable of storing and releasing lithium, the cathode comprising:
a lithium-nickel-manganese-cobalt compound oxide having a layered crystal structure and a lithium-manganese compound oxide having a layered crystal structure, wherein:
the cathode has the diffraction peak of the lithium-manganese compound oxide at the diffraction angle of 2θ=21.1±1° in the X-ray diffraction measurement using the Cu Kα line; and
the isolation rate of manganese in the lithium-manganese compound oxide in relation to cobalt of the lithium-nickel-manganese-cobalt compound oxide is 1% or less.

13. The lithium secondary battery according to claim 12, wherein the lithium-manganese compound oxide is Li₂MnO₃.
